(19) United States
(12) Patent Application Publication
(10) Pub. No.: US 2026/0043913 A1
(43) Pub. Date: Feb. 12, 2026

(54) RADAR APPARATUS AND RADAR SYSTEM

(71) Applicant: Panasonic Automotive Systems Co., Ltd., Kanagawa (JP)

(72) Inventors: Yuki TERAKADO, Kanagawa (JP); Junji SATO, Tokyo (JP); Tomohiro YUI, Kanagawa (JP)

(73) Assignee: Panasonic Automotive Systems Co., Ltd., Kanagawa (JP)

(21) Appl. No.: 19/275,635

(22) Filed: Jul. 21, 2025

(30) Foreign Application Priority Data
Aug. 7, 2024 (JP) 2024-130822

(51) Int. Cl. G01S 13/75; G01S 13/931

(52) U.S. Cl. CPC G01S 13/75; G01S 13/931; G01S 2013/93271; G01S 2013/93273; G01S 2013/93276; G01S 2013/9329

(57) ABSTRACT

A radar apparatus according to one aspect of the present disclosure includes a radar module that emits a transmission signal, and a re-emitter that re-emits the transmission signal by at least one of penetration and/or reflection.

### TECHNICAL FIELD

The present disclosure relates to a radar apparatus and a radar system.

### BACKGROUND ART

Recently, technology development of monitoring (sensing) related to automatic driving, driving support, and detection of a state of an occupant has been actively performed. Millimeter-wave radar apparatuses have been adopted as one of the technologies for monitoring. In addition to a radar apparatus that monitors the front, a radar apparatus that monitors the rear and the side is also employed in automatic driving and driving support. In addition, a radar apparatus that monitors the inside of a vehicle cabin is also employed for detecting a state of an occupant. The range to be monitored by the radar apparatus continues to increase in accordance with the sophistication of the vehicle, and the number of radars to be mounted also increases. Increasing the number of radar apparatuses mounted increases the cost of mounting the radar apparatus and the cost of maintenance such as calibration of the radar apparatus. Therefore, a radar apparatus that can be used for a plurality of applications in which a wide range is monitored by one radar apparatus has been studied.

For example, Patent Literatures (hereinafter referred to as “PTLs”) 1 and 2 propose a technique having a mechanism for monitoring both the outside and the inside of a vehicle cabin with a single radar apparatus. In these techniques, a radar is disposed on a side mirror of an automobile, and the outside of the vehicle is monitored during traveling, and the inside of the vehicle is monitored when the side mirror is folded (during parking).

### CITATION LIST

### Patent Literature

### PTL 1

Japanese Patent Application Laid-Open No. 2004-142660

### PTL 2

Japanese Patent Application Laid-Open No. 2007-174390

### SUMMARY OF INVENTION

The present disclosure facilitates providing a radar apparatus and a radar system that are capable of monitoring the inside and outside of a vehicle cabin by a single radar apparatus.

A radar apparatus according to one aspect of the present disclosure includes: a radar module, which in operation, emits a transmission signal; and a re-emitter, which in operation, re-emits the transmission signal by at least one of penetration and/or reflection.

A radar system according to one aspect of the present disclosure is a radar system in which a radar apparatus including a radar module, which in operation, emits a transmission signal, and a re-emitter, which in operation, re-emits the transmission signal by at least one of penetration and/or reflection is configured to be mounted on a vehicle.

### Advantageous Effects of Invention

According to one exemplary embodiment of the present disclosure, it is possible to monitor the range of the inside and outside of a vehicle cabin with one radar apparatus.

### BRIEF DESCRIPTION OF DRAWINGS

FIG. 1A illustrates a state of a vehicle viewed from the side;

FIG. 1B illustrates the state of the vehicle as viewed from above;

FIG. 2A illustrates the state of the vehicle viewed from the side;

FIG. 2B illustrates the state of the vehicle as viewed from above;

FIG. 3A illustrates the state of the vehicle viewed from the side;

FIG. 3B illustrates the state of the vehicle as viewed from above;

FIG. 4A illustrates the state of the vehicle as viewed from above;

FIG. 4B illustrates the state of the vehicle viewed from the side;

FIG. 5A illustrates the state of the vehicle as viewed from above;

FIG. 5B illustrates the state of the vehicle viewed from the side;

FIG. 6 illustrates the state of the vehicle as viewed from above;

FIG. 7 illustrates the state of the vehicle viewed from the side;

FIG. 8 illustrates an exemplary configuration of a re-emitter; and

FIG. 9 illustrates connection between radar apparatus and ECU.

### DESCRIPTION OF EMBODIMENTS

Hereinafter, embodiments of the present disclosure will be described in detail with reference to the drawings as appropriate.

### Embodiment 1

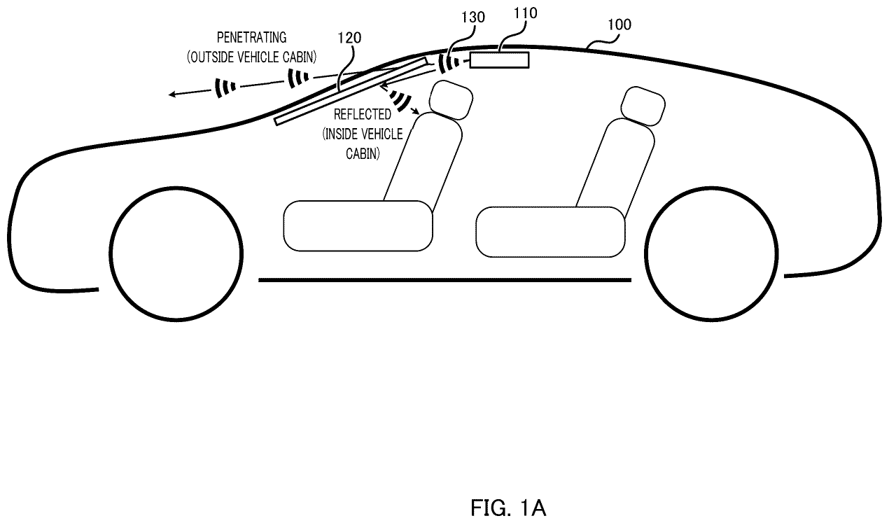

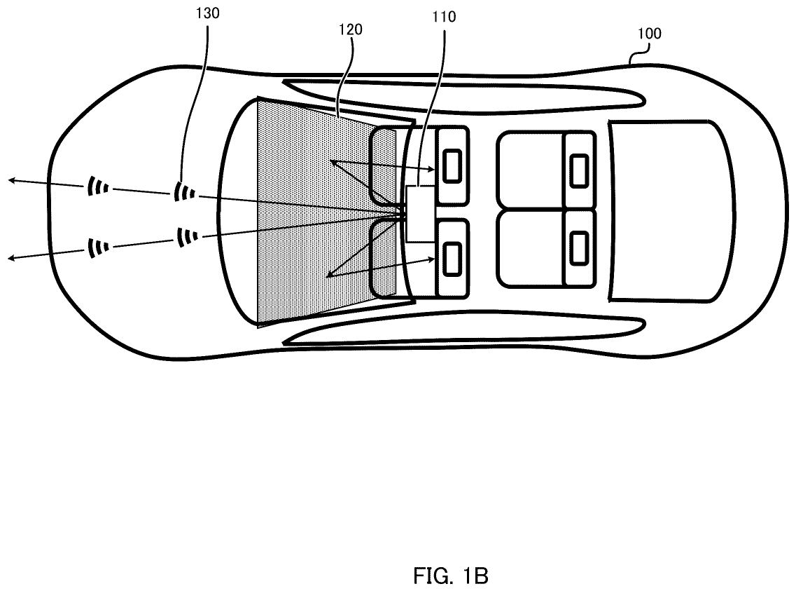

FIGS. 1A and 1B are diagrams illustrating a radar apparatus according to an embodiment.

The radar apparatus is configured to be mounted on vehicle 100 and includes radar module 110 and re-emitter 120.

Radar module 110 is configured to be mounted, for example, on a ceiling inside a vehicle cabin. Radar module 110 emits, for example, millimeter waves as transmission signal 130. Radar module 110 may emit radio waves of other frequencies as transmission signal 130. In FIGS. 1A and 1B, the directivity (main emission direction) of a radio wave that is transmission signal 130 is indicated by a straight line. Transmission signal 130 may be a narrow beam to be scanned or a wide beam. In addition, radar module 110 can detect the position and the moving velocity of a target by receiving a reflected wave, which is transmission signal 130 reflected by the target.

Re-emitter 120 is configured to be mounted on, for example, a windshield. For example, re-emitter 120 is disposed on substantially the entire surface of the windshield. Re-emitter 120 may be formed of a metasurface. Re-emitter 120 re-emits transmission signal 130 emitted by radar module 110. Re-emitter 120 may control at least one of penetration and/or reflection to control a direction of re-emission in re-emitting transmission signal 130. Re-emitter 120 is made of a transparent material so as not to interfere with the field of view of a driver. The configuration of re-emitter 120 will be described later.

Re-emitter 120 allows penetration of transmission signal 130 and re-emits the transmission signal to the outside of the vehicle cabin, so that the target outside the vehicle cabin can be monitored. Re-emitter 120 reflects transmission signal 130 and re-emits it into the vehicle cabin, so that an occupant inside the vehicle cabin can be monitored. The monitoring of the occupant includes not only acquisition of the presence or absence of the occupant but also acquisition of a vital signal of the occupant. The re-emission direction of re-emitter 120 shown in FIGS. 1A and 1B is merely exemplary, and re-emission is performed in an appropriate direction depending on the arrangement of the seats of vehicle 100. The direction of re-emission may be changed depending on a region by which re-emitter 120 reflects transmission signal 130 and/or the time in which transmission signal 130 is reflected.

Here, when re-emitter 120 is formed of a film having a periodic structure such as a metasurface, the reflection/penetration may be switched by electrically switching ON/OFF with respect to re-emitter 120 (for example, ON=reflection, OFF=penetration). Further, re-emitter 120 may control the directivity by providing areas with phase shifts and areas that are electrically switchable between ON and OFF states in the periodic structure of re-emitter 120. For example, re-emission toward a front seat and re-emission toward a rear seat of vehicle 100 may be switched according to the region and/or time.

Further, by switching the state of re-emitter 120 between a state for allowing penetration of transmission signal 130 and a state for reflecting transmission signal 130, it is possible to monitor both the outside of the vehicle cabin and the inside of the vehicle cabin with single radar module 110.

Further, when radar module 110 is configured to be mounted on the ceiling inside the vehicle cabin to monitor the outside of vehicle 100, re-emitter 120 is in a transmissive state (e.g., allowing penetration without control for reflection), so that the structure of re-emitter 120 can be simplified. Further, since the monitoring of the outside of the vehicle cabin and the inside of the vehicle cabin is switched by switching the state of re-emitter 120, the switching between the outside of the vehicle cabin and the inside of the vehicle cabin in a range to be monitored can be performed in a short time. In addition, the front seat or the rear seat can be monitored by re-emitter 120 changing the direction of re-emission into the vehicle cabin. Transmission signal 130 reflected by the target inside or outside the vehicle cabin penetrates through re-emitter 120 or is reflected by re-emitter 120 in the direction of radar module 110. Radar module 110 may emit transmission signal 130 to the rear of the vehicle, and re-emitter 120 may be disposed on the rear window.

### Embodiment 2

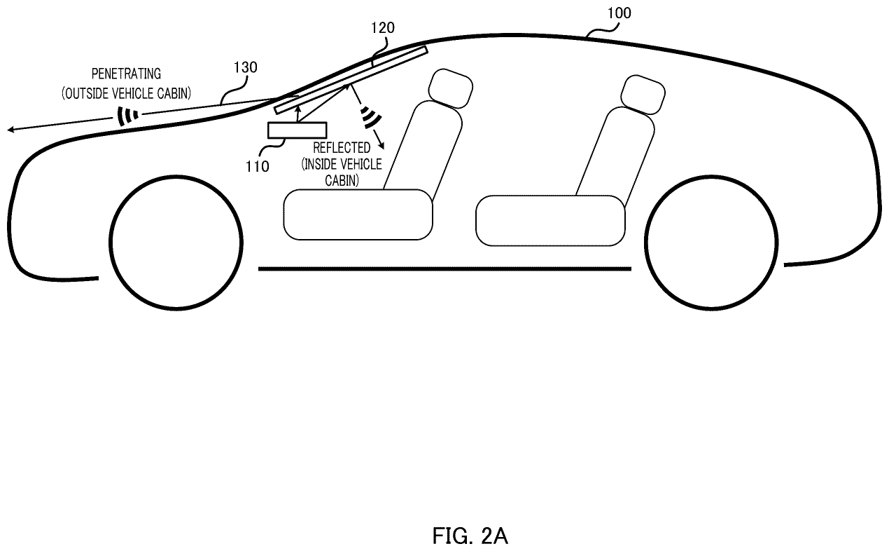

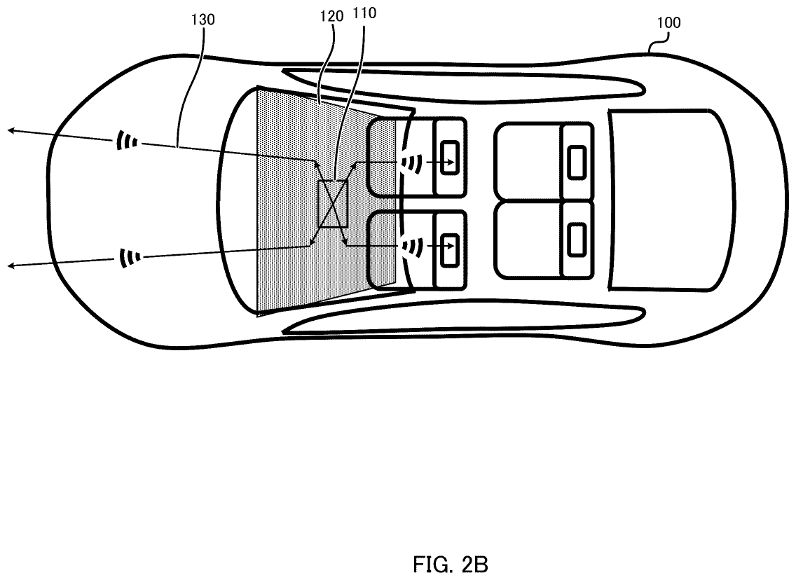

FIGS. 2A and 2B are diagrams for describing the radar apparatus according to Embodiment 2.

In Embodiment 1, radar module 110 is configured to be mounted on the ceiling inside the vehicle cabin, but in Embodiment 2, radar module 110 is configured to be mounted on, for example, a dashboard.

When performing re-emission to the outside of the vehicle cabin, re-emitter 120 allows penetration of transmission signal 130 while controls the directivity of it, instead of simply becoming the transmissive state.

The present embodiment is identical to Embodiment 1 in the other respects.

According to Embodiment 2, by mounting radar module 110 on the dashboard, it is possible to reduce the feeling of pressure to the occupant from above, and to improve the aesthetic appearance in the vehicle cabin.

### Embodiment 3

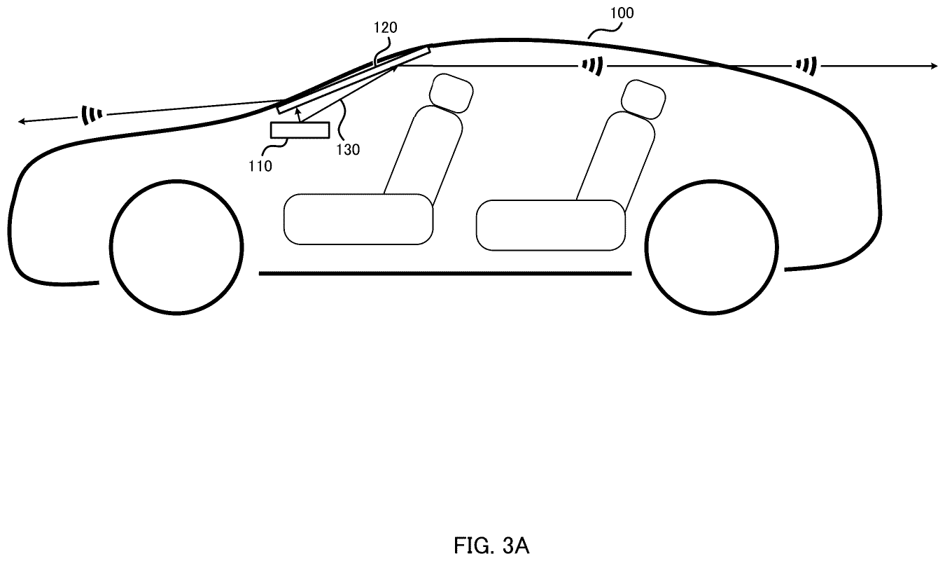

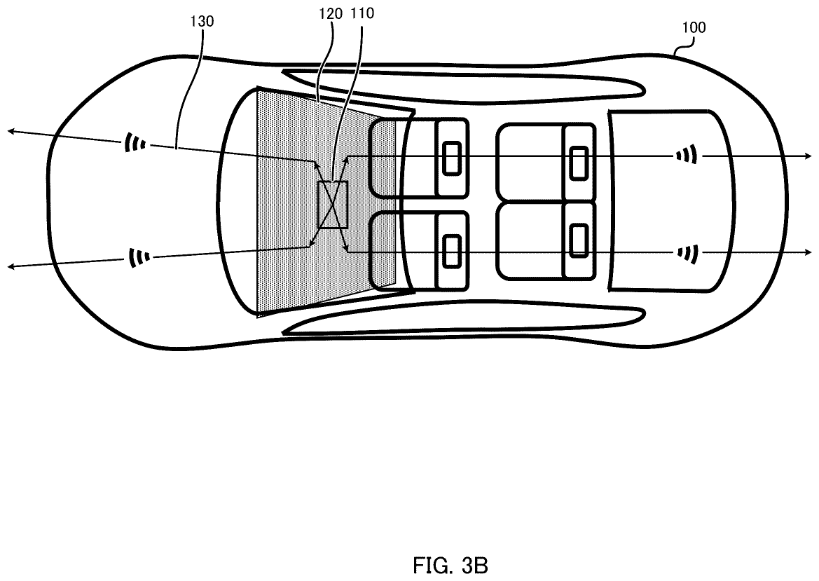

FIGS. 3A and 3B are diagrams for describing the radar apparatus according to Embodiment 3.

In Embodiments 1 and 2, when re-emitter 120 re-emits transmission signal 130 into the cabin, the re-emission is performed to allow monitoring of the occupant in the cabin, whereas in Embodiments 3, re-emitter 120 performs re-emission such that the direction of re-emission is changeable and the rear of vehicle 100 can be monitored through the rear window of vehicle 100. In FIGS. 3A and 3B, radar module 110 is configured to be mounted on the dashboard as in Embodiment 2, but the radar module may be configured to be mounted on the ceiling of the vehicle cabin as in Embodiment 1.

The present embodiment is identical to Embodiment 1 or 2 in the other respects.

According to Embodiment 3, the rear of vehicle 100 can be monitored by re-emitter 120 changing the direction of re-emission of transmission signal 130.

### Embodiment 4

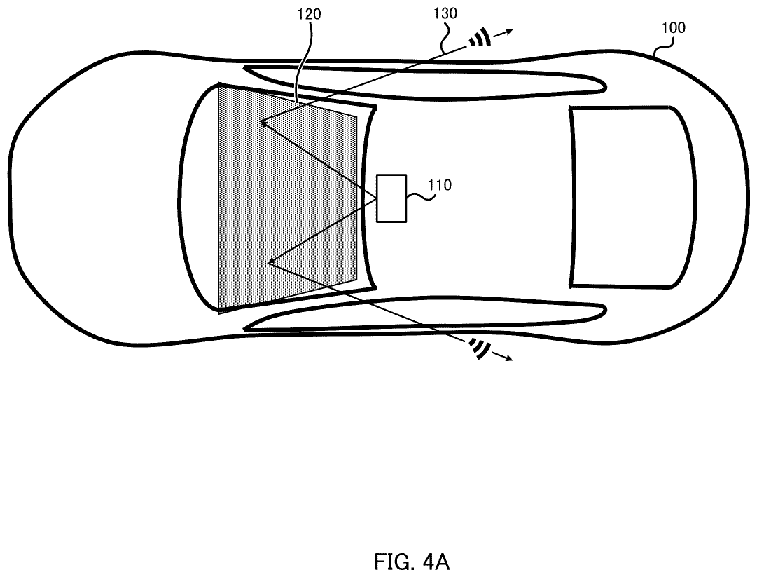

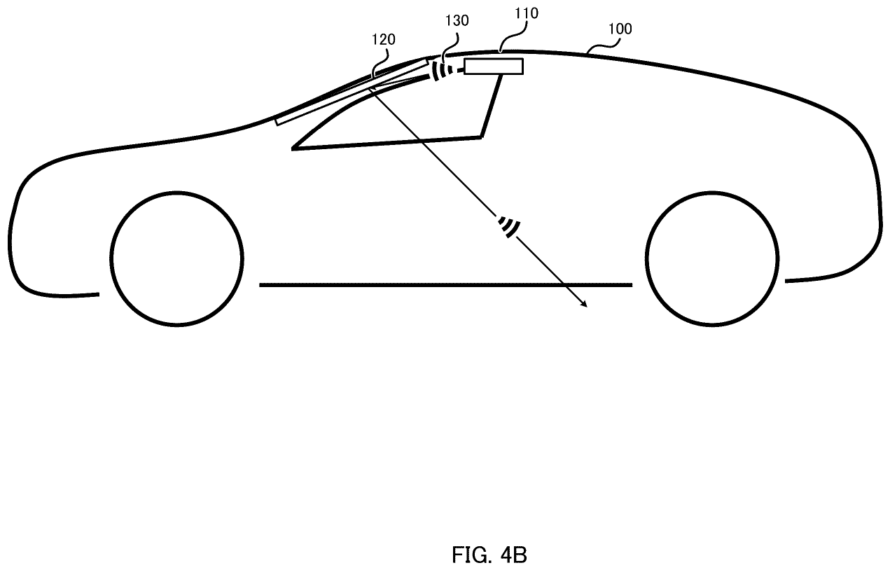

FIGS. 4A and 4B are diagrams for describing the radar apparatus according to Embodiment 4. In FIGS. 4A and 4B, seats are not shown.

In FIGS. 4A and 4B, transmission signal 130 emitted from radar module 110 and transmission signal 130 re-emitted by re-emitter 120 are shown, and transmission signal 130 penetrating through re-emitter 120 is not shown.

In Embodiments 1 and 2, when re-emitter 120 re-emits transmission signal 130 into the vehicle cabin, transmission signal 130 is re-emitted such that the occupant in the vehicle cabin can be monitored, but in Embodiment 4, re-emitter 120 changes the direction of re-emission and performs re-emission such that the lateral sides of vehicle 100 can be monitored. In FIGS. 4A and 4B, radar module 110 is configured to be mounted on the ceiling inside the vehicle cabin as in Embodiment 1, but radar module 110 may be configured to be mounted on the dashboard as in Embodiment 2.

The present embodiment is identical to Embodiments 1 to 3 in the other respects.

According to Embodiment 4, re-emitter 120 can monitor the lateral sides of vehicle 100 by changing the direction of re-emission of transmission signal 130.

### Embodiment 5

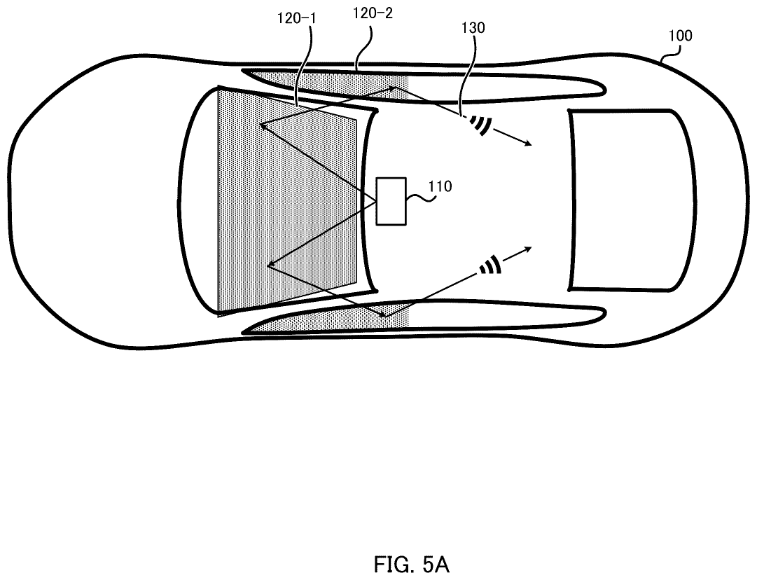

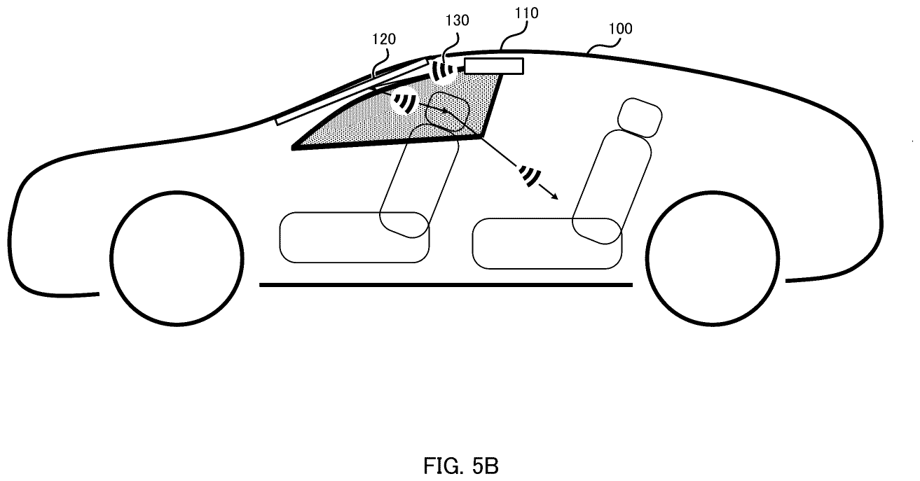

FIGS. 5A and 5B are diagrams for describing the radar apparatus according to Embodiment 5. In FIGS. 5A and 5B, transmission signal 130 emitted from radar module 110 and transmission signal 130 re-emitted by re-emitter 120 are shown, but transmission signal 130 penetrating re-emitter 120 is not shown. Also, in FIG. 5A, seats are not shown.

In Embodiment 5, the re-emitter includes re-emitter 120-1 disposed on the windshield and re-emitter 120-2 disposed on the side window. Re-emitter 120-2 may be disposed on glass of a fixed window (a window not to be opened and closed). FIGS. 5A and 5B are diagrams illustrating a state in which re-emitter 120-1 disposed on the windshield is in a reflective state and re-emitter 120-2 disposed on the side window is in the reflective state, thereby monitoring the rear seat. By setting re-emitter 120-2 disposed on the side window in the transmissive state, the lateral sides of vehicle 100 can be monitored as in Embodiment 4. Blind spots of lower lateral portions of vehicle 100 may be monitored by controlling the directivity when re-emitter 120-2 disposed on the side window re-emits (allows penetration of) transmission signal 130 to the outside of the vehicle cabin.

Re-emitter 120-2 may be disposed on the side mirror. Re-emitter 120-2 disposed on the side mirror can monitor the rear seat or the lateral sides of vehicle 100 by controlling the directivity of re-emission of transmission signal 130. The direction in which transmission signal 130 is re-emitted may be controlled in accordance with the movement (angle) of the side mirror in re-emitter 120-2 configured to be mounted on the side mirror.

The present embodiment is identical to Embodiments 1 to 4 in the other respects.

According to Embodiment 5, since the rear seat can be monitored from the direction of the side window by using re-emitter 120-2 disposed on the side window, the rear seat can be monitored regardless of the situation of the front seat. By providing re-emitter 120-2 on the glass of the fixed window which does not open and close, stable monitoring can be performed without being affected by the opening and closing of the side window.

### Embodiment 6

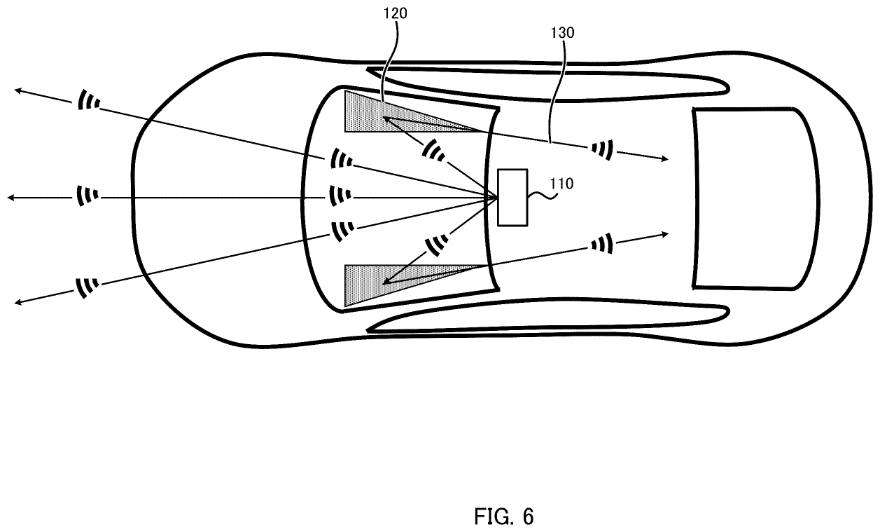

FIG. 6 is a diagram illustrating a radar apparatus according to Embodiment 6. In FIG. 6, the seats are not shown.

In Embodiments 1 to 5, the re-emitter is disposed on substantially the entire surface of the windshield, but in Embodiment 6, re-emitter 120 is disposed on a part of the windshield. For example, re-emitter 120 is disposed on the left and right end portions of the windshield. Since transmission signal 130 penetrates through the windshield of a portion where re-emitter 120 is not disposed, the outside of the vehicle cabin can be monitored. Further, re-emitter 120 re-emits transmission signal 130 into the vehicle cabin to monitor the vehicle cabin. Similar to Embodiment 5, re-emitter 120 may also be disposed on the side window or the side mirror.

The present embodiment is identical to Embodiments 1 to 5 in the other respects.

According to Embodiment 6, since re-emitter 120 at least partially reflects transmission signal 130 (for example, re-emitter 120 is disposed on a part of the windshield), it is possible to minimize the time or region in which it is difficult to monitor the outside of the vehicle cabin.

### Embodiment 7

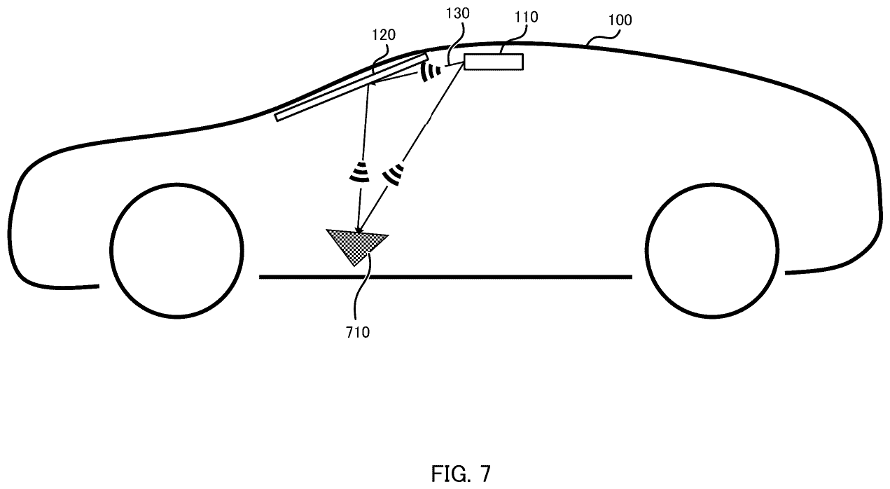

FIG. 7 is a diagram illustrating a radar apparatus according to Embodiment 7. In FIG. 7, the seats are not shown.

In Embodiment 7, reference object 710 is disposed in the vehicle cabin in the case of Embodiments 1 to 6. Reference object 710 may directly receive transmission signal 130 from radar module 110, or may receive transmission signal 130 re-emitted by re-emitter 120. By using reference object 710, radar module 110 and re-emitter 120 can be calibrated (calibrated/corrected). Note that no new object need to be mounted, and an object in the vehicle cabin can be reference object 710. For example, a structure on a center console, a door knob, a pillar of a vehicle, or the like may be reference object 710. Calibration may be performed with respect to a plurality of reference objects 710.

Here, reference object 710 that directly receives transmission signal 130 from radar module 110 and reference object 710 that receives a re-emission signal re-emitted by re-emitter 120 do not need to be the same. For example, a door knob may be used as reference object 710 that directly receives transmission signal 130 from radar module 110, and a structure on the center console may be used as reference object 710 that receives the re-emission signal re-emitted by re-emitter 120.

Radar module 110 and re-emitter 120 configured to be mounted on the vehicle in Embodiments 1 to 6 can be calibrated by using reference object 710 of Embodiment 7.

Since reference object 710 in the vehicle cabin is fixed at a predetermined position when vehicle 100 is manufactured, it is possible to perform calibration with high accuracy and a small number of man-hours (low load), and it does not affect the design or aerodynamic characteristics. In addition, both radar module 110 and re-emitter 120 can be calibrated.

### (Configuration of Re-Emitter 120)

The configuration of re-emitter 120 in Embodiments 1 to 7 will be described. Re-emitter 120 may switch between allowing penetration of transmission signal 130 (re-emission in a first direction) and reflecting transmission signal 130 (re-emission in a second direction) based on at least one of time, a frequency at which re-emission is performed, and/or a region of re-emitter 120 where transmission signal 130 is re-emitted. Re-emitter 120 may be capable of switching re-emissions in more than two directions.

Re-emitter 120 may be formed of a metasurface. The metasurface can allow penetration of or reflect transmission signal 130 emitted by radar module 110, by an external control signal, for example. Re-emitter 120 can switch the penetration or reflection of transmission signal 130 by switching the control signal according to time.

Re-emitter 120 may be constituted by a radio wave control sheet. The radio wave control sheet can be reflective at a specific frequency and allow penetration at a frequency other than the specific frequency. The radio wave control sheet may allow penetration at a frequency of a part of transmission signal 130 and be reflective at other frequencies of transmission signal 130. For example, when radar module 110 transmits radio waves in the range of 77 to 81 GHz as transmission signal 130, the radio wave control sheet may reflect a radio wave of 77 GHz of transmission signal 130 and allow penetration of radio waves in the range of 78 to 81 GHz of the transmission signal. Re-emitter 120 can switch between penetration and reflection depending on the frequency. In the radio wave control sheet, the frequency of transmission signal 130 to be reflected and the frequency of transmission signal 130 to be transmitted may be switched by a control signal. For example, the radio wave control sheet may reflect the radio wave in the range of 77 to 80 GHz and allow penetration of the radio wave of 81 GHz in accordance with the control signal.

In this way, by using the radio wave control sheet as re-emitter 120, it is possible to monitor the inside and outside of the vehicle cabin.

The description has been given in which re-emitter 120 can switch the penetration (re-emission in the first direction) and the reflection (re-emission in the second direction) and can further control the directivity. The specific configuration will then be described.

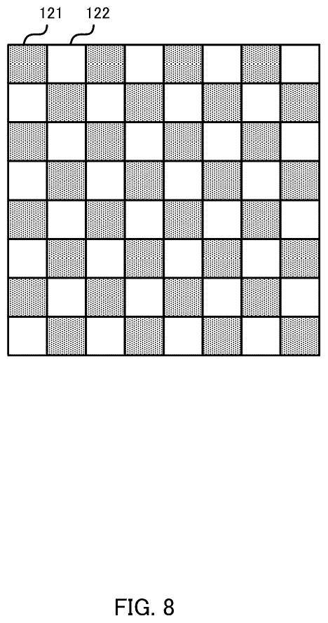

In FIG. 8, for example, in re-emitter 120, region 121 that reflects transmission signal 130 and region 122 that allows penetration of transmission signal 130 may be arranged in a checkerboard pattern. Note that regions 121 for reflection and regions 122 for penetration are not limited to a checkerboard pattern, and may be arranged in any shape.

In addition, in re-emitter 120, elements that reflect transmission signal 130 may be configured in any shape on the transparent film. Region 122 that allows penetration of transmission signal 130 may be a transparent film, and region 121 that reflects transmission signal 130 may be the elements on the transparent film. Re-emitter 120 can allow penetration of transmission signal 130 in transparent film portions and reflect transmission signal 130 in element portions that reflect the transmission signal.

Further, re-emission in three or more directions may be switched by performing a plurality of times of reflection by using a plurality of re-emitters 120.

The metasurface, the radio wave control sheet, and the arrangement may be combined. For example, region 121 that reflects transmission signal 130 and region 122 that allows penetration of the transmission signal described in FIG. 8 may be formed from a metasurface to switch the direction of re-transmission of transmission signal 130 depending on time.

As re-emitter 120, for example, a metasurface formed on a conductive transparent film can be used. Here, re-emitter 120 can control penetration and reflection of the transmission signal by applying the control signal to an ultrafine wire disposed in the conductive transparent film. To this end, the ultrafine wires may be arranged on the conductive transparent film in accordance with region 121 for reflection and region 122 for penetration, or may be arranged in an arbitrary shape. In addition, in the region where the transmission signal is reflected, a driver can visually check the outside of the vehicle through re-emitter 120.

### (Connection Between Radar Apparatus and ECU)

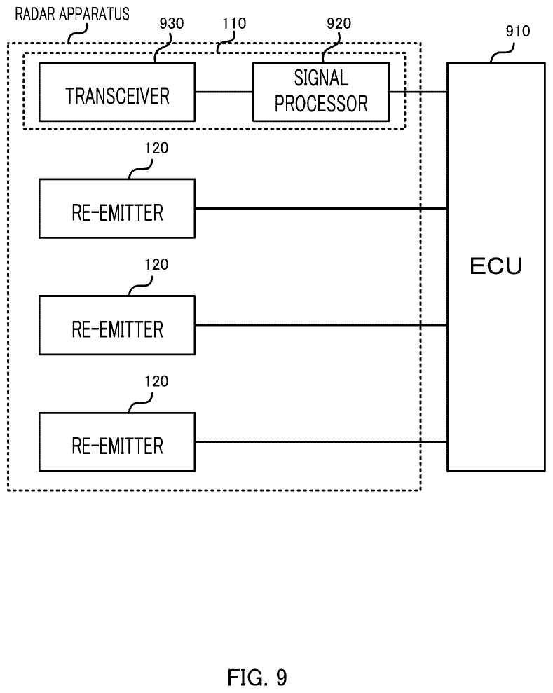

In FIG. 9, Electronic Control Unit (ECU) 910 is connected to re-emitter 120, which is formed, for example, from a metasurface, and is connected to radar module 110. Radar module 110 includes Digital Signal Processor (DSP) 920 and transceiver 930.

ECU 910 switches the direction in which re-emitter 120 re-emits transmission signal 130. Radar module 110 and re-emitter 120 are synchronized, and radar module 110 recognizes that a reflected signal detected when re-emitter 120 is in a state of allowing penetration of transmission signal 130 is a reflected signal by a target outside the vehicle cabin, while recognizing that a reflected signal detected when re-emitter 120 is in a state of reflecting transmission signal 130 is a reflected signal by a target inside the vehicle cabin. Synchronization of radar module 110 and re-emitter 120 may be performed by ECU 910, by another device, or by mutual operation of radar module 110 and re-emitter 120.

DSP 920 performs signal processing or the like for radar module 110 based on the control of ECU 910. For example, DSP 920 calculates the distance from vehicle 100 to the target and the direction in which the target exists, based on the information on the direction in which re-emitter 120 re-emits transmission signal 130, the information on the reflected signal reflected by the target, and the like. The radar apparatus may be configured using a plurality of radar modules.

Transceiver 930 emits a transmission signal based on the control of DSP 920.

Note that ECU 910 may be directly connected to radar module 110, and ECU 910 may perform signal processing instead of DSP 920.

When performing calibration, ECU 910 controls radar module 110 and re-emitter 120 so that transmission signal 130 is along the path shown in FIG. 7.

ECU 910 may control radar module 110 and re-emitter 120 according to the state of vehicle 100. For example, ECU 910 may control radar module 110 and re-emitter 120 so as to perform calibration prior to delivery (delivery of the vehicle), detect intrusion to the vehicle or a left-behind person in the vehicle during parking (detection in the vehicle cabin), and perform detection in the outside and the inside of the vehicle cabin during traveling. In addition, ECU 910 may monitor the front of the vehicle and the inside of the vehicle when moving forward, and may monitor the rear of the vehicle and the side of the vehicle when moving backward.

Further, ECU 910 may control the direction in which re-emitter 120 re-emits transmission signal 130 such that the direction of a previously detected target (or a newly detected target) is detected as a center. Thus, highly accurate detection of the target can be performed.

### (Combination of Techniques Disclosed in Embodiments)

The techniques disclosed in the embodiments can be combined. For example, by combining the techniques disclosed in Embodiments 1, 3, and 4, the directivity when re-emitter 120 re-emits transmission signal 130 can be directed to the seat, the rear of the vehicle, and the lateral sides of the vehicle. Further, by combining the techniques disclosed in Embodiments 1 and 5, monitoring can be performed by the technique disclosed in Embodiment 5 even when monitoring of the rear seat cannot be sufficiently performed by the technique disclosed in Embodiment 1.

In these cases, the directivity may be controlled based on the frequency of transmission signal 130, the directivity may be controlled based on a control signal from the ECU or the like, or the directivity may be controlled based on the location of re-emitter 120 disposed on the windshield.

As a method of adjusting the region for reflection, for example, as in Embodiment 6, a location where re-emitter 120 is mounted may be selected, or as shown in FIG. 8, the region for reflection may be adjusted by the region of re-emitter 120, or a location where re-emitter 120 is mounted may be selected and then the region for reflection may be adjusted by the region of re-emitter 120.

In the description of the embodiment described above, the expression of each component may be replaced with another expression using “circuit (circuitry),” “assembly,” “device,” “unit,” or “module.”

In addition, the present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

(1) A radar apparatus according to one aspect of the present disclosure includes: a radar module, which in operation, emits a transmission signal; and a re-emitter, which in operation, re-emits the transmission signal by at least one of penetration and/or reflection.

(2) The radar apparatus according to one aspect of the present disclosure is the radar apparatus of (1), in which the re-emitter is constituted by a metasurface.

(3) The radar apparatus according to one aspect of the present disclosure is the radar apparatus of (1), in which the re-emitter allows penetration of the transmission signal at a first time and reflects the transmission signal at a second time different from the first time.

(4) The radar apparatus according to one aspect of the present disclosure is the radar apparatus of (1), in which a first region of the re-emitter allows penetration of the transmission signal, and a second region of the re-emitter different from the first region reflects the transmission signal.

(5) The radar apparatus according to one aspect of the present disclosure is the radar apparatus of (1), in which the radar module emits, as the transmission signal, a transmission signal of a first frequency and a transmission signal of a second frequency different from the first frequency, and the re-emitter allows penetration of the transmission signal of the first frequency and reflects the transmission signal of the second frequency.

(6) A radar system according to one aspect of the present disclosure is a radar system, in which the radar apparatus of (1) is configured to be mounted on a vehicle.

(7) In the vehicle according to one aspect of the present disclosure, the radar module is configured to be mounted on a cabin of the vehicle, and the re-emitter is configured to be mounted on glass of the vehicle in the radar system of (6).

(8) In the vehicle according to one aspect of the present disclosure, the re-emitter is configured to be mounted on left and right end portions of a windshield of the vehicle in the radar system of (7).

(9) In the vehicle according to one aspect of the present disclosure, the radar module is configured to be mounted on a ceiling of a cabin of the vehicle in the radar system of (7).

(10) In the vehicle according to one aspect of the present disclosure, the radar module is configured to be mounted on a dashboard of the vehicle in the radar system of (7).

(11) In the vehicle according to one aspect of the present disclosure, the re-emitter allows penetration of the transmission signal when re-emitting the transmission signal to an outside of a vehicle cabin and the re-emitter reflects the transmission signal when re-emitting the transmission signal into an inside of the vehicle cabin in the radar system of (7).

(12) In the vehicle according to one aspect of the present disclosure, the re-emitter reflects the transmission signal when the radar apparatus performs calibration, and allows penetration of the transmission signal when a target outside a vehicle cabin is detected in the radar system of (11).

(13) In the vehicle according to one aspect of the present disclosure, the re-emitter reflects at least a part of the transmission signal during parking of the vehicle, and allows penetration of at least a part of the transmission signal during traveling of the vehicle in the radar system of (11).

(14) In the vehicle according to one aspect of the present disclosure, the glass is a windshield of the vehicle, and the re-emitter reflects the transmission signal in a direction of a seat in a cabin of the vehicle when re-emitting the transmission signal into the cabin of the vehicle in the radar system of (11).

(15) In the vehicle according to one aspect of the present disclosure, the glass is a windshield of the vehicle, and the re-emitter reflects the transmission signal in a direction of a rear window of the vehicle when a target behind the vehicle is detected in the radar system of (11).

(16) In the vehicle according to one aspect of the present disclosure, the glass is a windshield of the vehicle, and the re-emitter reflects the transmission signal in a direction of a side window of the vehicle when re-emitting the transmission signal into the cabin of the vehicle in the radar system of (11).

(17) In the vehicle according to one aspect of the present disclosure, the glass is a windshield and a side window of the vehicle, and the re-emitter includes a first re-emitter configured to be mounted on the windshield and a second re-emitter configured to be mounted on the side window, and when the re-emitter re-emits the transmission signal into the cabin of the vehicle, the first re-emitter reflects the transmission signal in a direction of the side window, and the second re-emitter reflects the transmission signal reflected by the first re-emitter in a direction of a rear seat in the vehicle cabin in the radar system of (11).

(18) In the vehicle according to one aspect of the present disclosure, the glass is a windshield and a side window of the vehicle, and the re-emitter includes a first re-emitter configured to be mounted on the windshield and a second re-emitter configured to be mounted on the side window, and when the re-emitter re-emits the transmission signal to a lateral side of the vehicle, the first re-emitter reflects the transmission signal in a direction of the side window, and the second re-emitter allows penetration of the transmission signal reflected by the first re-emitter, the penetration being to the lateral side of the vehicle in the radar system of (11).

(19) In the vehicle according to one aspect of the present disclosure, the glass is a windshield of the vehicle, the re-emitter is configured to be mounted on the windshield and a side mirror, and the re-emitter includes a first re-emitter configured to be mounted on the windshield and a second re-emitter configured to be mounted on the side mirror, and when the re-emitter re-emits the transmission signal into the vehicle cabin, the first re-emitter reflects the transmission signal in a direction of the side mirror, and the second re-emitter reflects the transmission signal reflected by the first re-emitter in a direction of a rear seat in the vehicle cabin in the radar system of (11).

(20) In the vehicle according to one aspect of the present disclosure, when performing calibration, the radar module performs calibration by emitting the transmission signal or re-emitting the transmission signal to a fixed object in the vehicle in the radar system of (11).

(21) In the vehicle according to one aspect of the present disclosure, the radar apparatus is controlled by an Electronic Control Unit (ECU) of the vehicle in the radar system of (6).

(22) In the vehicle according to one aspect of the present disclosure, the ECU controls the radar module and the re-emitter according to a state of the vehicle in the radar system of (21).

(23) In the vehicle according to one aspect of the present disclosure, the radar module is synchronized with the re-emitter in the radar system of (21).

While various embodiments have been described herein above, it is to be appreciated that various changes in form and detail may be made without departing from the sprit and scope of the disclosure(s) presently or hereafter claimed.

This application is entitled and claims the benefit of Japanese Patent Application No. 2024-130822, filed on Aug. 7, 2024, the disclosure of which including the specification, drawings and abstract is incorporated herein by reference in its entirety.

### INDUSTRIAL APPLICABILITY

The present disclosure is useful for an in-vehicle radar apparatus and a radar system.

### REFERENCE SIGNS LIST

100 Vehicle
110 Radar module
120 Re-emitter
121 Region that reflects transmission signal
122 Region that allows penetration of transmission signal
130 Transmission signal
710 Reference object
910 ECU
920 DSP
930 Transceiver

1. A radar apparatus, comprising:
a radar module, which in operation, emits a transmission signal; and
a re-emitter, which in operation, re-emits the transmission signal by at least one of penetration and/or reflection.

2. The radar apparatus according to claim 1, wherein
the re-emitter is constituted by a metasurface.

3. The radar apparatus according to claim 1, wherein
the re-emitter allows penetration of the transmission signal at a first time, and reflects the transmission signal at a second time different from the first time.

4. The radar apparatus according to claim 1, wherein
a first region of the re-emitter allows penetration of the transmission signal, and a second region of the re-emitter different from the first region reflects the transmission signal.

5. The radar apparatus according to claim 1, wherein
the radar module emits, as the transmission signal, a transmission signal of a first frequency and a transmission signal of a second frequency different from the first frequency, and the re-emitter allows penetration of the transmission signal of the first frequency and reflects the transmission signal of the second frequency.

6. A radar system in which the radar apparatus according to claim 1 is configured to be mounted on a vehicle.

7. The radar system according to claim 6, wherein:
the radar module is configured to be mounted on a cabin of the vehicle, and
the re-emitter is configured to be mounted on glass of the vehicle.

8. The radar system according to claim 7, wherein
the re-emitter is configured to be mounted on left and right end portions of a windshield of the vehicle.

9. The radar system according to claim 7, wherein
the radar module is configured to be mounted on a ceiling of the cabin of the vehicle.

10. The radar system according to claim 7, wherein
the radar module is configured to be mounted on a dashboard of the vehicle.

11. The radar system according to claim 7, wherein:
the re-emitter allows penetration of the transmission signal when re-emitting the transmission signal to an outside of the cabin of the vehicle, and
the re-emitter reflects the transmission signal when re-emitting the transmission signal into the cabin of the vehicle.

12. The radar system according to claim 11, wherein
the re-emitter reflects the transmission signal when the radar apparatus performs calibration, and allows penetration of the transmission signal when the radar apparatus detects a target outside the cabin of the vehicle.

13. The radar system according to claim 11, wherein
the re-emitter reflects at least a portion of the transmission signal during parking of the vehicle, and allows penetration of at least a portion of the transmission signal during travel of the vehicle.

14. The radar system according to claim 11, wherein:
the glass is a windshield of the vehicle, and
the re-emitter reflects the transmission signal in a direction of a seat in the cabin of the vehicle when re-emitting the transmission signal into the cabin of the vehicle.

15. The radar system according to claim 11, wherein:
the glass is a windshield of the vehicle, and
the re-emitter reflects the transmission signal in a direction of a rear window of the vehicle when a target behind the vehicle is detected.

16. The radar system according to claim 11, wherein:
the glass is a windshield of the vehicle, and
the re-emitter reflects the transmission signal in a direction of a side window of the vehicle when re-emitting the transmission signal into the cabin of the vehicle.

17. The radar system according to claim 11, wherein:
the glass is a windshield and a side window of the vehicle,
the re-emitter includes a first re-emitter configured to be mounted on the windshield and a second re-emitter configured to be mounted on the side window, and
when the re-emitter re-emits the transmission signal into the cabin of the vehicle,
the first re-emitter reflects the transmission signal in a direction of the side window, and
the second re-emitter reflects, in a direction of a rear seat in the cabin of the vehicle, the transmission signal reflected by the first re-emitter.

18. The radar system according to claim 11, wherein:
the glass is a windshield and a side window of the vehicle,
the re-emitter includes a first re-emitter configured to be mounted on the windshield and a second re-emitter configured to be mounted on the side window, and
when the re-emitter re-emits the transmission signal toward a lateral side of the vehicle,
the first re-emitter reflects the transmission signal in a direction of the side window, and
the second re-emitter allows penetration of the transmission signal reflected by the first re-emitter, the penetration being toward the lateral side of the vehicle.

19. The radar system according to claim 11, wherein:
the glass is a windshield of the vehicle,
the re-emitter is disposed on the windshield and a side mirror,
the re-emitter includes a first re-emitter disposed on the windshield and a second re-emitter disposed on the side mirror, and
when the re-emitter re-emits the transmission signal into a vehicle cabin,
the first re-emitter reflects the transmission signal in a direction of the side mirror, and
the second re-emitter reflects, in a direction of a rear seat in the vehicle cabin, the transmission signal reflected by the first re-emitter.

20. The radar system according to claim 11, wherein
when calibration is performed, the radar module emits the transmission signal or the re-transmitter re-emits the transmission signal to a fixed object in the vehicle.
